(19) United States
(12) Patent Application Publication
(10) Pub. No.: US 2005/0115532 A1
(43) Pub. Date: Jun. 2, 2005

(54) Internal combustion engine and gasket therefor

(76) Inventor: Peter Schueren, Krefeld (DE)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 10/973,488

(22) Filed: Oct. 26, 2004

(30) Foreign Application Priority Data
Oct. 28, 2003 (DE) DE 10350127.4

(51) Int. Cl. F01M 9/10; F02F 11/00

(52) U.S. Cl. 123/90.37; 123/90.38

(57) ABSTRACT

An internal combustion engine having a cylinder head and a cam cover, which are sealed with one another at mutually facing joint surfaces by means of a gasket, the cylinder head having at least one cut-out extending through the wall of the cylinder head at the joint surface facing the cam cover further includes a gasket has a projection extending into the cut-out which sealingly closes the cut-out and the gasket has at least one side-face projecting lip disposed on a side face of the projection to engage laterally around an edge of the cooperating cut-out.

### TECHNICAL FIELD OF THE INVENTION

The invention relates to an internal combustion engine with a cylinder head and a valve or cam cover, which are sealed with one another at their mutually facing joint surfaces by means of a gasket, the cylinder head having a cut-out extending through the wall of the cylinder head at the joint surface facing the cam cover.

### BACKGROUND OF THE INVENTION

In a conventional internal combustion engine, the cylinder head closes off the top of the crankcase or cylinder tube and accommodates the gas exchange elements and ignition plug and/or injection valves. In conjunction with the piston, it may also form the desired combustion chamber shape. The entire valve control system may also for the most part be accommodated in the cylinder head of certain motor vehicle engines, including the camshaft, which may be mounted to the cylinder head. The chamber formed by the cylinder head is covered by the cam cover and, this being the case, the required leak-proof closure is provided by means of a gasket between the two components. Conventionally, care is taken to ensure that the respective joint surface on the cylinder head and on the cam cover is as flat as possible, so that a gasket that is simple in terms of its structure, and in particular, that is flat, sits between these parts, to ensure a reliable sealing function. In order further to enhance this function, it is also common practice to mill a groove into the joint surface in the cam cover, in which a projecting lip of this gasket locates. This prevents any undesirable shifting of the gasket during assembly.

In practical terms, because control elements that are important to the function of the internal combustion engine are disposed on the cylinder head, the mounting positions, valve seats, etc., must be designed to the highest degree of accuracy. What this means as regards the design of the bearing points for the cam shaft is that they must match one another as exactly as possible. In practice, this has therefore led to a processing method whereby these bearing points are made in one step during which the external walls of the cylinder head are also processed, enabling this processing step to be rendered more efficient. In order to provide the required freedom of movement for the processing tool, appropriate cut-outs are therefore provided on the joint surface of the cylinder head, which are usually semi-circular in shape.

However, this means that there are additional orifices in the wall of the cylinder head, which then have to be closed and sealed. One approach that was considered as a solution to this problem was to provide projections on the joint surface of the cam cover at the points of these cut-outs, the shape of which complements that of the cut-outs. However, the disadvantage of this approach was found to be the fact that the upper surface of the joint surface of the cam cover was not flat as a result. Manufacturing the cam cover to this design was therefore made very much more complicated. In addition, making the groove for the sealing lip turned out to be especially complex because it must conform to the contour of the joint surface on the cam cover if the sealing effect is to be reliable. The gasket itself was also more difficult to make as a result of this design and the required leak-tight seal of the arrangement can therefore be impaired as a result of the complex design of the gasket.

### SUMMARY OF THE INVENTION

Accordingly, the underlying objective of the invention is to improve an internal combustion engine so that it can be produced by a processing method that is practical in terms of the complexity involved, whereby the required tight seal is guaranteed at the interface between the cylinder head and the cam cover.

This objective is achieved by means of an internal combustion engine having the features defined in claim 1. It is distinctive in particular due to the fact that the gasket incorporates a projection at a point in the cylinder head which has a matching cut-out, which sealingly closes the cut-out, and at least one side-face projecting lip is provided on a side face of the projection, which laterally locates around an edge of the associated cut-out in the cylinder head.

The invention therefore adopts a solution based on a new approach, whereby the projection needed in order to close off the cut-out on the cylinder head is provided not on the cam cover but on the gasket. Accordingly, the cam cover does not have to be changed and can be made to the conventional design, which means that it still has an essentially flat joint surface. The design of the groove needed for the lip on the gasket is therefore no more difficult to make than is the case with conventional cam covers.

For the purpose of the invention, therefore, only the design of the gasket is new, involving relatively little extra complexity and hence expense. As a result of the sealing properties of the material used, the projection provided on the gasket therefore has the advantage of simultaneously closing the cut-out and providing a tight seal in this region.

This projection is guaranteed to be correctly positioned in the cut-out as a result of the at least one lateral lip projecting out from a side face of the projection. In co-operation with the edge of the co-operating cut-out, it forms a type of positive fit, largely preventing any undesirable shifting of the gasket. In particular, a reliable sealing action is also advantageously guaranteed in this region.

The internal combustion engine proposed by the invention is therefore designed to provide a reliable seal and can be made with little complexity and expense. The internal combustion engine proposed by the invention is also distinctive due to the ease with which it can be assembled.

Advantageous embodiments of the internal combustion engine proposed by the invention are defined in the dependent claims.

For example, side-face projecting lips may be provided on both side faces of the projection, which laterally locate round the edges of the co-operating cut-out. Consequently, the wall of the cylinder head is engaged in this region, enabling the gasket to be even more reliably positioned and secured in this region. The resultant positive fit between the projection and the edges of the cut-out reliably prevents the projection from shifting sideways.

It is also of advantage if the at least one lip is disposed on the projection in the region where the projection is at its maximum projected distance. Since this region is the farthest away from the points between the joint surfaces on the cam cover and on the cylinder head across which the gasket stretches, it is susceptible to a higher risk of being dislodged from its intended position; consequently, the fact of especially providing the at least one lip in this region offers a particularly reliable way of preventing the projection from shifting.

In an alternative embodiment, two lips may be provided on each of the two side faces of the projection, disposed symmetrically with respect to the region where the projection is at its maximum projection distance, thereby providing a total of four points at which the projection is retained on the cut-out. This offers a particularly reliable means of positioning the projection in the cut-out.

In another alternative embodiment, the at least one lip extends across the entire projection along the associated side face, producing an uninterrupted positive fit in the entire region of the projection. This provides an extremely reliable way of retaining the projection in its position and a particularly effective sealing action.

### BRIEF DESCRIPTION OF THE DRAWINGS

The invention will be described in more detail below with reference to examples of embodiments illustrated in the appended drawings. Of these:

FIG. 1 is a perspective view showing a portion of an internal combustion engine and gasket proposed by the invention;

FIG. 2 is a perspective diagram of this detail, shown in partial section;

FIG. 3 is an enlarged view of a portion of FIG. 1 showing an alternative embodiment of the gasket; and

FIG. 4 is an enlarged view of a portion of FIG. 1 showing a second alternative embodiment of the gasket.

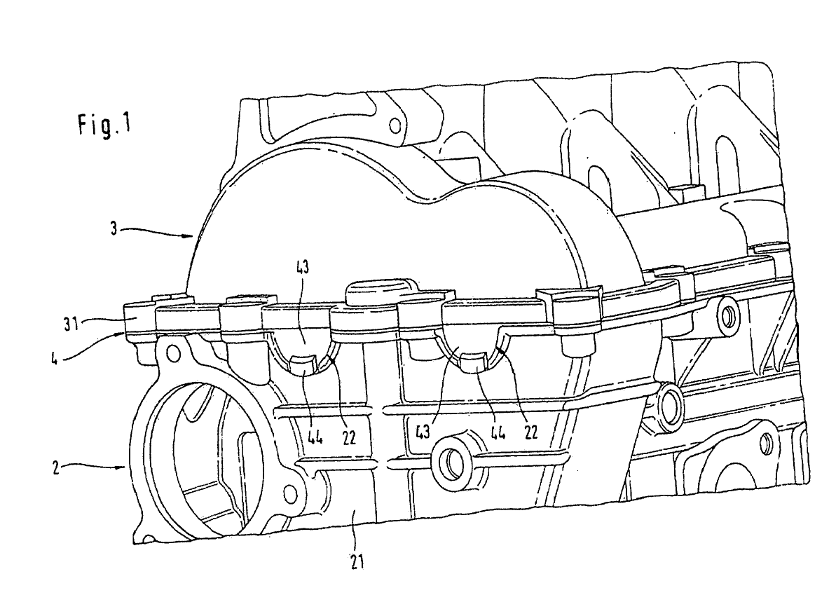

### DESCRIPTION OF THE PREFERRED EMBODIMENT

The diagrams given in the drawings show an internal combustion engine with a cylinder head 2, a cam cover 3 and a gasket 4 disposed in between.

The cylinder head 2 incorporates a wall 21, in which two cut-outs 22 of a substantially semi-circular shape are provided in this particular embodiment, extending through the wall 21. Matching cut-outs are also provided on the oppositely lying side of the cylinder head 2 (not shown). The cut-outs 22 extend through the wall 21 from a joint surface of the cylinder head 2 facing the cam cover 3, as illustrated in the drawings.

The cam cover 3 contains a flange 31, the bottom face of which serves as a joint surface which is joined to the top of cylinder head 2. The gasket 4 is compressed between the joint surface of the cylinder head 2 and the joint surface of the cam cover 3, once the fixing screws for these components, not illustrated in detail, are fitted.

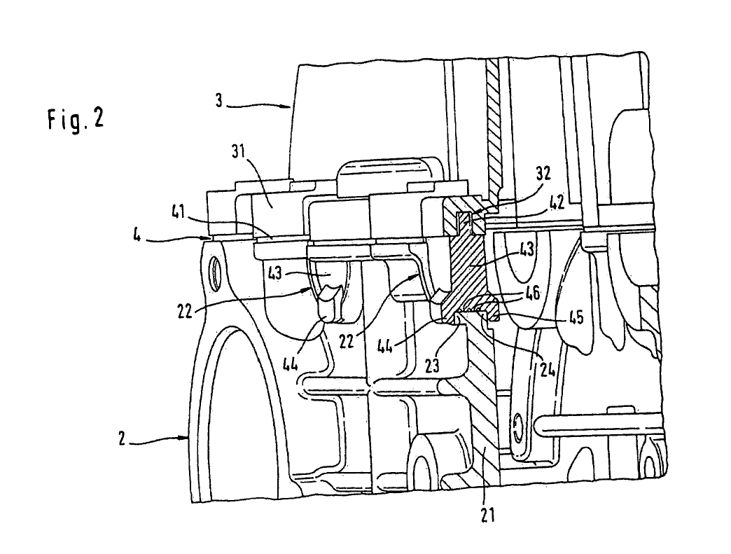

As may be seen in more detail from the section illustrated in the diagram of FIG. 2, the gasket 4 has a main sealing surface 41, which is compressed between the joint surfaces on the cylinder head 2 and cam cover 3. The gasket 4 also has a sealing lip 42, which extends in a groove 32 in the flange 31 of the cam cover 3. The sealing lip 42 helps to position the gasket 4 correctly on the flange 31.

At the points of the cut-outs 22, projections 43 extend out from the gasket 4 in the direction opposite the sealing lip 42. The projections 43 close off and seal the cut-outs 22. Lips 44 and 45 are provided on the side faces of the projections 43, each of which stands away from the side faces of the projections 43. The lips 44 and 45 are disposed in the region of the apex of the projections 43, i.e. in the region where the projection is at its maximum projection distance from the main sealing surface 41. The lips 44 and 45 engage the top portion of the wall 21 around the edges 23 and 24 of the cut-outs 22, resulting in a positive fit at this point. This reliably prevents any lateral shifting of a projection 43 relative to a cut-out 22.

As may also be seen from FIG. 2, the projections 43 have nubs 46 on their end faces, which further enhance the sealing effect in this region.

In addition to the embodiment illustrated, the invention lends itself to other variants.

For example, in many applications, it may be sufficient to provide only one lip 45 on the interior face in the cylinder head 2 because a pressure is likely to be generated from this side, and hence a force, which acts on the gasket 4 as a rule.

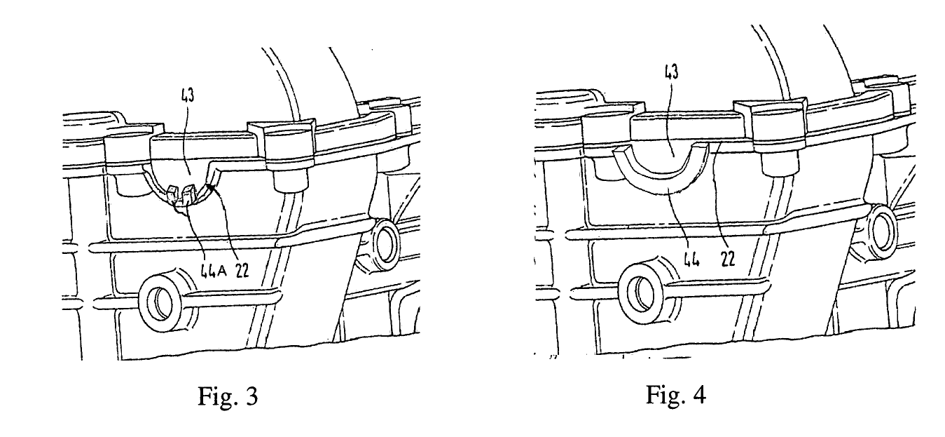

It would also be possible to provide a number of lips 44 and 45 greater than two on the projections. For example, in the alternative embodiment shown in FIG. 3, two lips 44a are provided on the side face of the projection 42, with the lips 44a disposed symmetrically about the region at which the projection 43 is at its maximum projection distance. As a further alternative, the lip 44 may extend around the entire contour of the projection 43 as shown in FIG. 4.

The cut-out 22 may also be of a shape other than semi-circular; for example, it may also be polygonal.

In other embodiments, it may also be that the gasket 4 does not have nubs 46 and/or the sealing lip 42.

Moreover, the number of cut-outs 22 and hence also projections 43 may vary, depending on the structural design of the internal combustion engine. In particular, these cut-outs may also be provided for reasons other than for making the camshaft bearings.

1. In an internal combustion engine having a cylinder head and a cam cover which are sealed with one another at mutually facing joint surfaces by means of a gasket, the cylinder head having a wall including at least one cut-out extending therethrough and opening to the joint surface facing the cam cover, the improvement wherein the gasket has a projection extending into and sealingly closing the cut-out and at least one side-face projecting lip is provided on a side face of the projection and engages laterally around an edge of the co-operating cut-out.

2. The invention of claim 1 wherein the side-face projecting lips are provided on both side faces of the projection and laterally engage around the inner and outer edges of the co-operating cut-out.

3. The invention of claim 2 wherein the at least one lip is disposed on the projection in the region at which the projection is at its maximum projection distance.

4. The invention of claim 2 wherein two lips are provided on at least one of the two side faces of the projection, the lips being disposed symmetrically with respect to the region at which the projection is at its maximum projection distance.

5. The invention of claim 2 wherein at least one lip extends along the associated side face around the entire periphery of the projection.

6. The invention of claim 1 the at least one lip is disposed on the projection in the region at which the projection is at its maximum projection distance.

7. The invention of claim 1 wherein two lips are provided on the side face of the projection, the lips disposed symmetrically with respect to the region at which the projection is at its maximum projection distance.

8. The invention of claim 1 wherein the at least one lip along the associated side face around the entire periphery of the projection.

9. A gasket for use to effect a seal between an internal combustion engine cylinder head and a cam cover generally along mutually facing parallel joint surfaces, the cylinder head further having a wall including at least one cut-out extending therethrough and opening to the joint surface facing the cam cover, comprising:
a main gasket body providing parallel sealing surfaces; and
a projection integrally formed on the main body and extending away from said main gasket body, said projection having a peripheral cut-out-engageable sealing surface conforming to said cut-out and at least one side-face projecting lip disposed on a side face of the projection, the lip extending to a distal edge disposed further from said main gasket body than said peripheral edge.

10. The gasket of claim 9 wherein said projection has a second side face and a second side-face projecting lip disposed on the second side face of the projection and extending to a distal edge disposed further from said main gasket body than said peripheral edge, said peripheral edge between disposed between said first and second lips.
